(19) United States
(12) Patent Application Publication
(10) Pub. No.: US 2007/0033351 A1
(43) Pub. Date: Feb. 8, 2007

(54) Semiconductor memory module unit for point-to-point data interchange

(76) Inventor: Hermann Ruckerbauer, Moos (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/377,473

(22) Filed: Mar. 16, 2006

(30) Foreign Application Priority Data
Mar. 16, 2005 (DE) 10 2005 012 129.2

(51) Int. Cl. G06F 13/00

(52) U.S. Cl. 711/154

(57) ABSTRACT

The invention describes a semiconductor memory module unit for P2P data interchange with a memory controller. Memory chips having different data widths can be arranged on the semiconductor memory module unit in such a way as to enable a tree-like branching by signal data transmission from a node-like memory chip to a plurality of downstream memory chips while retaining the data width.

### CROSS-REFERENCE TO RELATED APPLICATIONS

This Utility patent application claims priority to German Patent Application No. DE 10 2005 012 129.2, filed on Mar. 16, 2005, which is incorporated herein by reference.

### BACKGROUND

One embodiment of the invention relates to a semiconductor memory module unit for point-to-point (P2P) data interchange with a memory controller.

Memory systems of the DDR-1, DDR-2 and DDR-3 generations use a hybridT or a flyby connection for supplying DRAMs with command and address data (CA). In this case, different DRAMs are supplied with CA signals via a CA bus, as a result of which the speed of the CA bus is limited. Increasing speed requirements of DDR-4 or subsequent DRAM memory generations require fast bus systems. One bus system suitable therefor is the P2P connection between semiconductor memory modules and memory controller.

Semiconductor memory modules of the DDR-2 and DDR-3 memory generations such as DIMMs (dual inline memory modules), for example, enable the use of ×4 DRAM memory chips (×4: data width of 4 bits per memory access) instead of ×8 DRAMs by doubling the number of DRAMs on the semiconductor memory module. The doubled number of ×4 DRAMs compared with the number when ×8 DRAMs are mounted leads to the maintenance of the data width between semiconductor memory module and memory controller. If the storage capacities of an ×4 DRAM and an ×8 DRAM are identical, then the replacement of the ×8 DRAMs by the ×4 DRAMs with maintenance of the data width leads to a considerable increase in the total storage capacity on the semiconductor memory module. The doubling of the memory chips just described in the transition from ×8 DRAMs to ×4 DRAMs is made considerably more difficult with the use of a P2P connection between semiconductor memory module and memory controller. The reason for this is the two-fold feeding of the CA signals that is required in the transition from an ×8 DRAM to two ×4 DRAMs since, in the case of a P2P connection, a dedicated CA signal passes to each DRAM at the semiconductor memory module input. This does not appear to be very promising with regard to additionally required plug connections/pins and also the management on the part of the memory controller.

### SUMMARY

One embodiment of the invention provides a semiconductor memory module unit having memory chips having different data widths, for instance ×4 DRAMs and ×8 DRAMs, which is suitable for P2P data interchange with a memory controller whilst avoiding the above problems.

A semiconductor memory module unit for P2P data interchange with a memory controller according to one embodiment of the invention has module input signal data pins for receiving signal data from at least the memory controller, module output signal data pins for transmitting signal data to at least the memory controller, memory chips having chip input signal data pins and chip output signal data pins and suitable for storing and reading memory data bits (DQ), it being possible for signal data to be transmitted from the module input signal data pins via signal lines and memory chips that process the signal data unidirectionally in the direction of the module output signal data pins. In addition, the memory chips are interconnected in tree-like fashion proceeding from a memory chip connected to the module input signal data pins as far as memory chips connected to module output signal data pins, each connection from the module input signal data pins to the module output signal data pins including a matching number of memory chips. From a node-like memory chip, the tree structure is branched by transmission of signal data to a plurality of downstream memory chips, and each of the node-like memory chips, per memory access, can write or read a number of memory data bits (DQ) (that is, has a data width) which corresponds to the sum of the memory data bits (DQ) that can be written or read by the plurality of downstream memory chips per memory access (that is to say to the sum of the data widths of the plurality of downstream memory chips).

The tree structure of the memory chips interconnected in tree-like fashion can thus be developed by taking into account, proceeding from the memory chip connected to the module input signal data pins, a branching of the tree structure into a further underlying level of the tree if signal data are transmitted to a plurality of downstream memory chips. No branching of the tree structure into the further underlying level is provided if a superordinate memory chip transmits signal data only to one downstream memory chip. If all the connections are then taken into account proceeding from the memory chip connected to module input signal data pins as far as the memory chips connected to module output signal data pins, then the tree structure is attained. A branching of the tree structure is provided for example in the case of a node-like ×8 memory chip which transmits signal data to two downstream ×4 memory chips. In this case, a number of memory data bits (DQ) to be stored can be stored, depending on a memory address, either in the ×8 memory chip or in the two ×4 memory chips. The number of memory data bits (DQ) that can be stored or read per memory access is also referred to as the data width. Since each connection from the module input signal data pins to the module output signal data pins includes a matching number of memory chips, the memory chips connected to module output signal data pins lie at a common lowest level of the tree structure.

In one case, signal lines connected to the chip input signal data pins or chip output signal data pins are provided at least for transmitting signal data in the form of command and address data (CA), write data (wD), read data (rD) and a clock signal (CLK). In one case, the address data are used to determine the level of the tree structure in which memory data are intended to be processed, that is to say read or written. The CA data, write data and read data can be transmitted on different signal lines.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates in schematically illustrated fashion a first embodiment of the semiconductor memory module unit according to one embodiment of the invention.

FIG. 2 illustrates in schematically illustrated fashion a further embodiment of the semiconductor memory module unit according to one embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In one embodiment, the command and address data, the write data and the read data are at least partly transmitted on common signal lines. In contrast to semiconductor memory modules of the DDR-1, DDR-2 and DDR-3 memory generations, in which command and address data and memory data, that is to say write data and read data, are transmitted on separate lines, this embodiment, by virtue of transmission on common signal lines, results in pins being saved on the semiconductor memory module. Given a limited number of pins on the semiconductor memory module, cf. for instance a 168-pole interface of an EDO-DRAM memory module (JEDEC 21-C), it is thus possible to achieve a comparatively larger data width on the semiconductor memory module. In one case, the command and address data and also the memory data are transmitted completely on common signal lines, additional signal lines only being used if their data widths differ.

In one case, it is advantageous for the write data to be transmitted via a smaller number of signal lines in comparison with the read data. Since the requirements of rapidity are higher in the case of read operations, in order to avoid unnecessary waiting cycles on the part of the memory controller, than when writing data, it is possible to save module input signal data pins by using fewer signal lines for transmitting the write data from the memory controller to the semiconductor memory module unit compared with the transmission of the read data from the semiconductor memory module unit to the memory controller, said pins then being available for other purposes. In this case, however, it must be taken into consideration that the command and address data are possibly likewise to be transmitted on these signal lines.

In one embodiment, a point-to-n-point (P2nP) connection serves for transmitting the signal data from each of the node-like memory chips to in each case a plurality of n downstream memory chips. Such an interconnection between the node-like memory chips and the downstream memory chips entails the advantage that the node-like memory chip outputs the signal data independently of whether the latter are transmitted to one or a plurality of downstream memory chips. Consequently, on the node-like memory chip it is not necessary to take any precautions whatsoever, for example with regard to dividing the signal data in the case of a plurality of downstream memory chips, so that a customary memory chip of present-day memory generations can be used as the node-like memory chip. Thus, by way of example, an ×8 DRAM would transmit the signal data to a plurality of downstream memory chips in a manner as if a single ×8 DRAM were arranged downstream.

In one case, each of the n downstream memory chips, in the case of a P2nP connection, has a filter device which selects in each case an n-th portion from a bit data quantity of write data to be stored, the n downstream memory chips in each case selecting different portions of the bit data quantity to be stored, such that all the bits of the bit data quantity to be stored can be stored in the n downstream memory chips. For this purpose, for example in the case of a P22P connection, in which a node-like chip transmits signal data to two downstream memory chips, it is appropriate for one of the two downstream memory chips to select and store the first half of a burst of write data and the other of the two downstream memory chips to select and store the second half of the write data of the burst. A further possibility for filtering the data consists in the two memory chips selecting the memory data of respectively different chip output signal data pins of the node-like memory chip, that is to say one of the two memory chips, in the case of a P22P connection, selecting for example the memory data transmitted via one half of the output signal data pins of the node-like memory chip and the other of the two memory chips selecting the signal data transmitted via the other half of the output signal data pins of the node-like memory chip. However, this possibility of dividing the memory data is more difficult to realize with regard to data distribution on the DRAM memory chip in comparison with the division of the data burst as described in the introduction.

In a further embodiment, each of the node-like memory chips, in the case of a P2nP connection, has chip output signal data pins subdivided into n groups, and from each of the n groups of chip output signal data pins, at least a portion of the signal data can be transmitted to a respective one of the n downstream memory chips. It is thus possible, for example, for different portions of the write data and of the read data to be transmitted from each of the n groups. In addition, it is also possible for the command and address data and/or the clock signal to be transmitted via each of the groups. It is likewise possible for the clock signal to be transmitted separately via a P2nP connection.

In one embodiment, each of the node-like memory chips has a selection device which divides a bit data quantity of read data or write data into n portions and transmits a respective one of the n portions via one of the n groups of chip output data signal pins to a respective one of the n downstream memory chips. It is thereby ensured that the total bit data quantity is divided between the downstream memory chips. However, each of the downstream memory chips receives the command and address data and also the clock signal.

In one case, the selection device determines the n portions by dividing the bit data quantity of the burst of read or write data. In the case of a P22P connection, cf. for instance a node-like ×8 DRAM memory chip and two downstream ×4 DRAM memory chips, the selection device allocates for example one half of the burst to a first of the two ×4 DRAM memory chips and the other half of the burst to the second of the ×4 DRAM memory chips.

One embodiment has a node-like memory chip of the ×8 type and six memory chips of the ×4 type, the node-like memory chip of the ×8 type being connected to the module input signal data pins and transmitting the signal data to two downstream memory chips of the ×4 type, from where the signal data are transmitted without further branching via in each case two series-connected memory chips of the ×4 type to the module output signal data pins. If it is assumed that the storage capacity of the memory chip of ×8 type matches that of a memory chip of the ×4 type, e.g. the memory chips of the ×8 type and of the ×4 type each have a storage capacity of 1 GB, then such an arrangement of the memory chips on the semiconductor module unit leads to a considerable increase in the storage capacity of said semiconductor memory module unit. If, by way of example, only memory chips of the ×8 type are used on the semiconductor memory module unit, then given a number of four cascaded memory chips of the ×8 type each having a storage capacity of 1 GB, this results in a total storage capacity of 4 GB. If, however, directly downstream of the node-like memory chip of the ×8 type which is connected to the module input signal data pins, a branching to two downstream memory chips of the ×4 type is performed, then given identical interconnection of four cascaded memory chips and assuming that the storage capacity of an ×8 memory chip and that of an ×4 memory chip are 1 GB in each case, a total storage capacity of the module unit of 7 GB is obtained on account of the branching.

It should be expressly pointed out at this juncture that the tree structure is not restricted to a branching with two downstream memory chips, but rather may contain a plurality of branchings and also branchings having more than two downstream memory chips. By way of example, if memory chips of the ×16 type and memory chips of the ×4 type were available with an identical chip storage capacity, then with regard to a maximum storage capacity of the semiconductor memory module given a data width of 16 bits, the memory chip of the ×16 type would be suitable as the node-like memory chip which is connected to the module input signal data pins and which transmits signal data to four downstream memory chips of the ×4 type. It would likewise be possible for the memory chip of the ×16 type to transmit signal data to two downstream memory chips of the ×8 type which, for their part, may transmit signal data, with the aid of a further branching, to in each case two downstream memory chips of the ×4 type. A person skilled in the art will determine which tree structure is favorable for the realization of the semiconductor memory module unit by weighing up a plurality of factors, inter alia for instance the availability of memory chips having different data widths or else the maximum storage capacity per memory chip, etc.

It is particularly appropriate, in the embodiment with a node-like memory chip of the ×8 type and six memory chips of the ×4 type, to arrange the memory chip of the ×8 type and the two downstream memory chips of the ×4 type on a front side of a module carrier and the further four memory chips of the ×4 type on a rear side of the module carrier. In this case, it is advantageous to provide six of the module input signal data pins for receiving the command and address data and also the write data and a further one of the module input signal data pins for receiving the clock signal, and to provide eight of the module output signal data pins for transmitting at least the read data and two further pins from among the module output signal data pins for transmitting the clock signal. The provision of more pins for transmitting the read data in comparison with the transmission of the write data enables high bandwidths during the reading operation. Consequently, the duration of the reading operation can be shortened, whereby it is possible to reduce undesirable waiting cycles in the memory controller until the arrival of the read data from the semiconductor memory module unit.

In one case, the memory chips have matching storage capacities. This is provided for example in the case of ×4 and ×8 DRAM memory chips having a chip storage capacity of 1 GB. Consequently, a branching of an ×8 memory chip connected to the module input signal data pins into two downstream ×4 memory chips makes it possible to increase the storage capacity on the semiconductor module unit without increasing the data width.

In one case, the module carrier corresponds to that of a DIMM. A plurality of semiconductor memory module units are accommodated on a module carrier, the number of said module units is essentially determined by the data width of the DIMM and also the data width of the memory chips connected to the module input signal data pins.

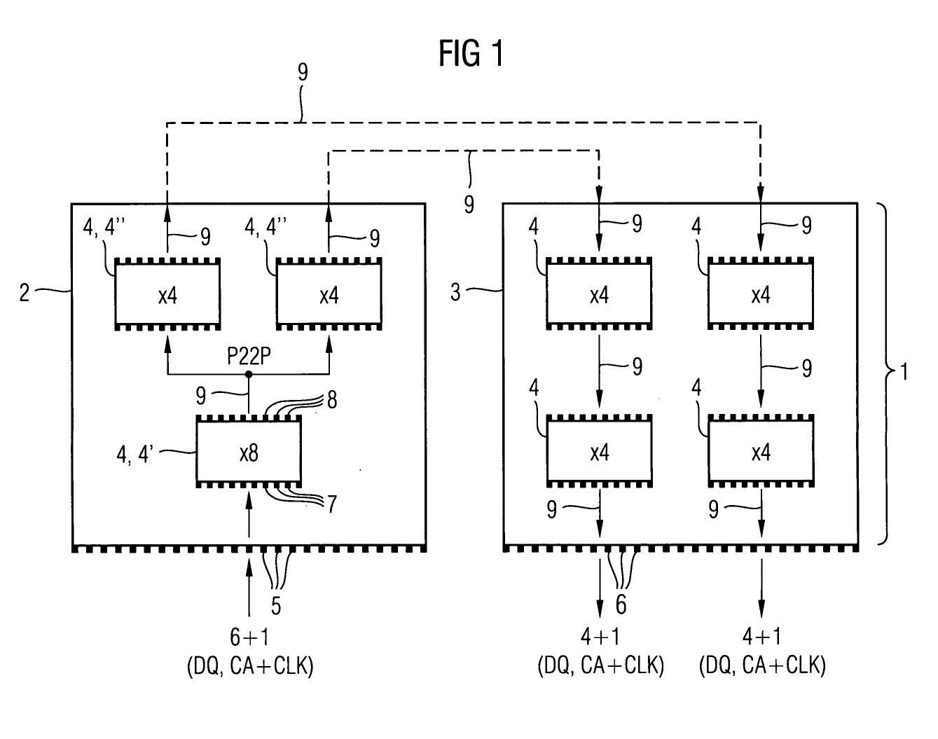

FIG. 1 illustrates a semiconductor memory module unit 1 having memory chips 4 arranged on a module carrier front side 2 and on a module carrier rear side 3. The memory chips are in one case DRAMs. The semiconductor memory module unit 1 has module input signal data pins 5 and module output signal data pins 6. The memory chips 4 likewise have chip input signal data pins 7 and also chip output signal data pins 8. The memory chips 4 are interconnected and also connected to the module input signal data pins 5 and to the module output signal data pins 6 via signal lines 9. A plurality of signal lines are illustrated in a simplified manner as a single line for the sake of clarity in FIG. 1. The signal lines 9 likewise serve for connecting memory chips 4 on the module carrier front side 2 to memory chips 4 on the module carrier rear side 3. The module input signal data pins 5 receive command and address data CA and also write data wD (that is to say memory data DQ) from the memory controller via six module input signal data pins. A clock signal CLK is received via a further module input signal data pin. These signal data are forwarded via the signal lines 9 to the chip input signal data pins 7 of a node-like memory chip 4′ of the ×8 type.

Although the memory chip 4′ of the ×8 type has a data width of 8 bits, that is to say permits writing or reading of eight data bits per memory access, the write data wD are only fed via six chip input signal data pins 5. Consequently, the entire bandwidth is not used for writing write data wD, which is advantageous in view of the lower speed requirements when writing in comparison with the reading operation and on account of the savings of pins on the semiconductor memory module unit 1.

The memory chip of the ×8 type represents a node-like memory chip 4′ since it transmits signal data to two downstream memory chips 4″ of the ×4 type. The designation node-like stems from the branching proceeding from the ×8 memory chip to the two downstream memory chips 4″ of the ×4 type. The arrangement of the memory chips 4 on the semiconductor memory module unit 1 thus has a tree structure in the case of which a branching proceeds from the node-like memory chip 4′. The node-like memory chip 4′ of the ×8 type transmits the signal data to the two downstream memory chips 4″ of the ×4 type with the aid of a point-to-2-point (P22P) connection, that is to say that the signal data are transmitted proceeding from the node-like ×8 memory chip 4′ via the chip output signal data pins 8 thereof independently of the number of downstream memory chips 4″. Consequently, it is not necessary to divide the signal data on the ×8 memory chip with regard to the two downstream memory chips 4″. This entails the advantage that the memory chip of the ×8 type may be a conventional memory chip of present-day memory generations.

The two downstream memory chips 4″ of the ×4 type receive the CA data, rD and wD data (referred to jointly as memory data DQ) and also the clock signal CLK. Data rD read in the node-like memory chip 4′ of the ×8 type are passed from the downstream memory chips 4″ of the ×4 type to the module output signal data pins 6 via eight signal lines (not illustrated). The two downstream memory chips 4″ of the ×4 type each have a filter device, which in each case filter out half of the write data wD. In one case, the filter device of the first one of the two downstream memory chips 4″ of the ×4 type filters out a first half of the burst of the write data wD for storage or forwarding and the filter device of the other of the two downstream memory chips 4″ filters out the second half of the write data wD from the burst for storage or forwarding.

If data are intended to be read from the two downstream memory chips 4″ of the ×4 type, then these data are forwarded via in each case four signal lines in each case to a further downstream memory chip of the ×4 type on the module carrier rear side 3. From there, the signal data pass via a respective further downstream memory chip of the ×4 type to the module output signal data pins 6. Each of the two memory chips of the ×4 type which are connected to the module output signal data pins 6 transmits the read data rD via four signal lines to in each case four module output signal data pins. The data width at the output of the semiconductor memory module unit 1 of 8 bits thus corresponds to the data width of the node-like memory chip 4′ of the ×8 type connected to the module input signal data pins 5. In addition to the read data rD, the clock signal CLK is also transmitted to the module output signal data pins 6 via further pins. Independently of the branching of the tree structure via which signal data are transmitted from the module input signal data pins 5 to the module output signal data pins 6, an identical number of four intervening memory chips 4 is included. Consequently, the signal propagation times from the module input signal data pins 5 to the module output signal data pins 6 are independent of the branching adopted on the semiconductor memory module unit 1.

The semiconductor memory module unit 1 is in one case accommodated multiply on a semiconductor memory module, in particular a DIMM. An interconnection of memory chips 4 as illustrated in FIG. 1 enables a total storage capacity of 7 GB assuming a maximum storage capacity of 1 GB for memory chips 4 both of the ×8 type and of the ×4 type. This results in a significant increase in the storage capacity compared with a semiconductor memory module unit in which only memory chips of the ×8 type are cascaded. In the latter case, the semiconductor memory module unit would only have a total storage capacity of 4 GB.

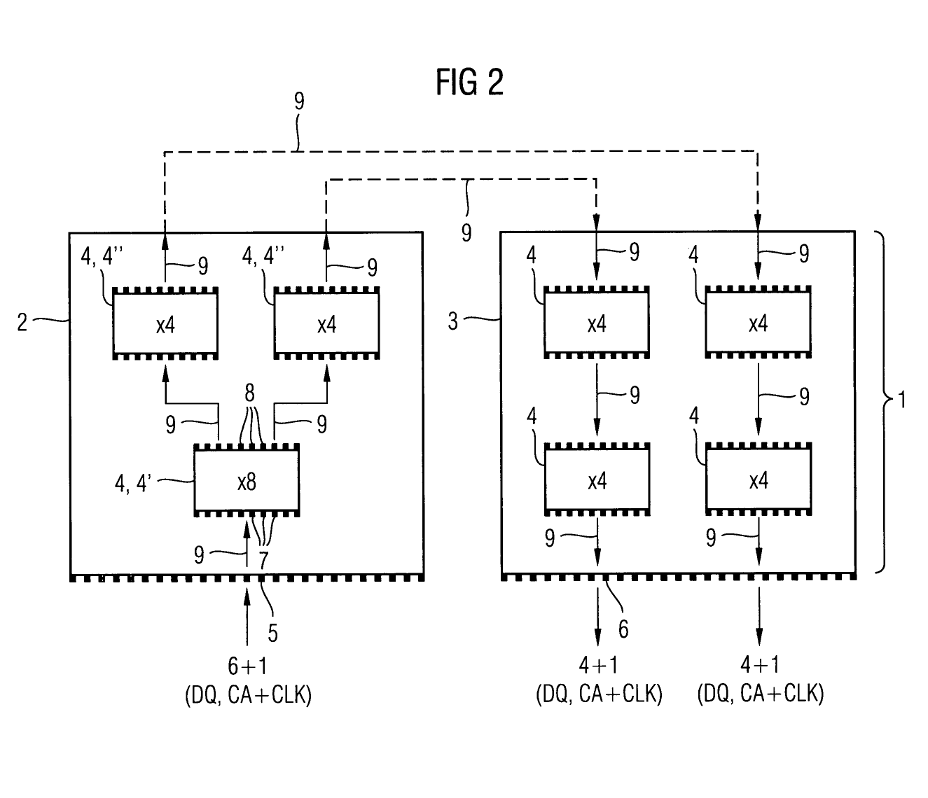

FIG. 2 illustrates in schematically illustrated fashion a further embodiment of the semiconductor memory module unit according to one embodiment of the invention. This module unit exhibits a similar construction compared to the first embodiment illustrated in FIG. 1. In contrast thereto, however, the signal data are transmitted from the node-like ×8 memory chip 4′ to the two downstream memory chips 4″ of the ×4 type not via a P22P connection. However, the node-like memory chip 4′ has chip output signal data pins subdivided into two groups (not illustrated) via which a respective portion of the signal data is transmitted to a respective one of the two downstream memory chips 4″ of the ×4 type. The signal data are divided with the aid of a selection device on the node-like memory chip 4′. Said selection device in one case assigns a first half of the memory data of the burst to the first group of chip output signal data pins and the second half of the memory data of the burst to the second group of chip output signal data pins. The clock signal CLK and also the command and address data CA are transmitted from the node-like memory chip 4′ to both downstream memory chips 4″ of the ×4 type. Data rD read in the node-like memory chip 4″ are likewise forwarded respectively to the extent of one half to one of the two downstream memory chips 4′ and to the extent of the other half to the other of the two downstream memory chips 4″. The connection of the two downstream memory chips 4″ of the ×4 type on the module carrier front side 2 to the further memory chips 4 on the module carrier rear side 3 and also the further signal transmission to the module output signal data pins 6 are effected in the manner illustrated in the figure description accompanying FIG. 1 and are not repeated again at this juncture.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor memory module unit for point-to-point (P2P) data interchange with a memory controller, comprising:
module input signal data pins for receiving signal data from at least the memory controller;
module output signal data pins for transmitting signal data to at least the memory controller;
memory chips having chip input signal data pins and chip output signal data pins and suitable for storing and reading memory data bits, it being possible for signal data to be transmitted from the module input signal data pins via signal lines and memory chips that process the signal data unidirectionally in the direction of the module output signal data pins;
wherein the memory chips are interconnected in tree-like fashion proceeding from a memory chip connected to the module input signal data pins as far as memory chips connected to module output signal data pins, each connection from the module input signal data pins to the module output signal data pins comprising a matching number of memory chips; in which case
wherein from a node-like memory chip, the tree structure is branched by transmission of signal data to a plurality of downstream memory chips; and
wherein each of the node-like memory chips, per memory access, can write or read a number of memory data bits which corresponds to the sum of the memory data bits that can be written or read by the plurality of downstream memory chips per memory access.

2. The semiconductor memory module unit of claim 1, wherein signal lines connected to the chip input or output signal data pins are provided at least for transmitting signal data in the form of command and address data, write data, read data and a clock signal.

3. The semiconductor memory module unit of claim 2, wherein the command and address data, the write data and the read data are at least partly transmitted on common signal lines.

4. The semiconductor memory module unit of claim 2, wherein the write data are transmitted via a smaller number of signal lines in comparison with the read data.

5. The semiconductor memory module unit of claim 1, wherein a point-to-n-point connection serves for transmitting the signal data from each of the node-like memory chips to in each case a plurality of n downstream memory chips.

6. The semiconductor memory module unit of claim 5, wherein each of the n downstream memory chips has a filter device which selects in each case an n-th portion from a bit data quantity of write data to be stored, the n downstream memory chips in each case selecting different portions of the bit data quantity to be stored, in such a way that all the bits of the bit data quantity to be stored can be stored in the n downstream memory chips.

7. The semiconductor memory module unit of claim 6, wherein the filter device selects the n-th portion of the bit data quantity of write data to be stored from a burst of write data bits.

8. The semiconductor memory module unit of claim 1, wherein each of the node-like memory chips has chip output signal data pins subdivided into n groups, and wherein from each of the n groups of chip output signal data pins, at least a portion of the signal data can be transmitted to a respective one of the n downstream memory chips.

9. The semiconductor memory module unit of claim 8, wherein each of the node-like memory chips has a selection device which divides a bit data quantity of read data or write data into n portions and transmits a respective one of the n portions via one of the n groups of chip output data pins to a respective one of the n downstream memory chips.

10. The semiconductor memory module unit of claim 9, wherein the selection device determines the n portions by dividing the bit data quantity of the burst of memory data.

11. The semiconductor memory module unit of claim 1, wherein a node-like memory chip of the ×8 type and six memory chips of the ×4 type, the node-like memory chip of the ×8 type being connected to the module input signal data pins and transmitting the signal data to two downstream memory chips of the ×4 type, from where the signal data are transmitted without further branching via in each case two series-connected memory chips of the ×4 type to the module output signal data pins.

12. The semiconductor memory module unit of claim 11, wherein the node-like memory chip of the ×8 type and the two downstream memory chips of the ×4 type are arranged on a front side of a module carrier and a further four memory chips of the ×4 type are arranged on a rear side of the module carrier.

13. The semiconductor memory module unit of claim 12, wherein six module input signal data pins are provided for receiving the command and address data and also the write data and a further module input signal data pin is provided for receiving the clock signal, and wherein eight module signal data pins are provided for transmitting at least the read data and two further module output signal data pins are provided for transmitting the clock signal.

14. The semiconductor memory module unit of claim 1, wherein the memory chips have matching storage capacities.

15. The semiconductor memory module unit of claim 12, wherein the module carrier corresponds to that of a dual inline memory module.

16. A semiconductor memory module configured for point-to-point data exchange with a memory controller comprising:
means for receiving signal data from the memory controller;
means for transmitting signal data to the memory controller;
a node-like memory chip coupled to the means for receiving signal data;
a matching number of memory chips coupled to the means for transmitting signal data;
a plurality of downstream memory chips branched out from the node-like memory chip thereby forming a tree structure by transmission of signal data from the node-like memory chip to the plurality of downstream memory chips;
wherein, per each memory access, the node-like memory chip writes or reads a number of memory data bits that corresponds to the sum of the memory data bits that can be written or read by the plurality of downstream memory chips per access.

17. The semiconductor memory module of claim 16, wherein signal lines transmit signal data from the means for receiving data signals to memory chips for processing.

18. The semiconductor memory module of claim 17, wherein the means for receiving signal data includes module input signal data pins.

19. The semiconductor memory module of claim 18, wherein the means for transmitting signal data includes module output signal data pins.

20. The semiconductor memory module unit of claim 19, wherein signal lines connected to the chip input or output signal data pins are provided at least for transmitting signal data in the form of command and address data, write data, read data and a clock signal.
